(19) United States
(12) Patent Application Publication
(10) Pub. No.: US 2026/0149402 A1
(43) Pub. Date: May 28, 2026

(54) TRANSFER SYSTEM AND CONTROL DEVICE

(71) Applicant: MITSUBISHI ELECTRIC CORPORATION, Tokyo (JP)

(72) Inventors: Yuji IGARASHI, Tokyo (JP); Kenji TAKAHASHI, Tokyo (JP); Tatsuya KAWASE, Tokyo (JP)

(73) Assignee: MITSUBISHI ELECTRIC CORPORATION, Tokyo (JP)

(21) Appl. No.: 19/490,975

(22) PCT Filed: Aug. 3, 2023
(86) PCT No.: PCT/JP2023/028460

§ 371 Date: Dec. 8, 2025

(51) Int. Cl. H02P 25/064; B65G 54/02; H02K 41/03

(52) U.S. Cl. CPC H02P 25/064; B65G 54/02; H02K 41/031

(57) ABSTRACT

A transfer system includes a drive unit that supplies drive currents to coils disposed along a transfer path, a thrust command generation unit that generates a thrust command that is the command value of a thrust to be produced by a mover, based on a motion target value that is a time-series motion target value, and a current command generation unit that generates, as current commands, current target values that are the target values of the drive currents to be provided to coils so that the thrust produced by the mover follows the thrust command. The current command generation unit generates the current target values to be provided to coils, using part of an actual thrust characteristic determined by the characteristics of the plurality of coils and the mover, so as to reduce the number of the coils through which the drive currents flow.

### FIELD

The present disclosure relates to a transfer system for transferring objects, and a control device included in the transfer system.

### BACKGROUND

Transfer systems for transferring workpieces are generally used in production lines in which factory automation is introduced, for example, production lines for assembling industrial products, production lines for packaging food, etc. In recent years, a transfer system has been widely used in which a transfer path for transferring workpieces is divided into a plurality of zones, and carriages on which the workpieces are placed are caused to travel by control devices disposed in the respective zones. This transfer system is a transfer system excellent in terms of production efficiency.

A form of a transfer system uses a so-called moving-magnet linear motor in which magnets are disposed on a carriage as a mover, and coils are disposed on a stator constituting a transfer path. The moving-magnet linear motor is suitable for long-distance transfer as compared with a moving-coil linear motor using coils as a mover. On the other hand, when a longer-distance transfer relative to the mover size is required of the moving-magnet linear motor, multiple coils are required according to the transfer distance. Furthermore, it is desired that the transfer system using the moving-magnet linear motor can control a plurality of carriages individually, and can control the movements of the plurality of carriages with high accuracy even when the carriages are adjacent to each other.

Patent Literature 1 below discloses a transfer system using a linear motor. The transfer system disclosed in Patent Literature 1 includes carriages including magnets and a plurality of coil units arranged in a transfer path. Each coil unit includes a plurality of coils. The transfer system disclosed in Patent Literature 1 produces thrusts to move the carriages by the interactions between the currents flowing through the coils and the magnetic fields produced by the magnets. The transfer system includes a control unit. The control unit determines the ratios of the currents to be supplied to the respective coil units, based on the positions of the plurality of carriages, and the respective impedances and thrust characteristics of the plurality of coil units. Patent Literature 1 describes that even when the carriages are controlled with the plurality of coil units, the carriages can be controlled with high accuracy.

### CITATION LIST

### Patent Literature

Patent Literature 1: Japanese Patent Application Laid-open No. 2017-79569 (JP 2017-79569 A)

### SUMMARY OF INVENTION

### Problem to be Solved by the Invention

The transfer system disclosed in Patent Literature 1 is provided with switches in addition to current control units that control the currents flowing to the coils. The transfer system disclosed in Patent Literature 1 needs to generate and output opening and closing commands to control the switches. Consequently, the transfer system according to Patent Literature 1 has a problem that a circuit configuration is complicated since the switches are required. Further, the transfer system according to Patent Literature 1 needs to generate and output the opening and closing commands in addition to current commands, and thus has a problem that processing to control the transfer system is complicated.

The present disclosure has been made in view of the above. It is an object of the present disclosure to provide a transfer system that can simplify a circuit configuration and allows control by simple processing.

### Means to Solve the Problem

In order to solve the above-described problems and achieve the object, a transfer system according to the present disclosure is a transfer system including a mover and a transfer path along which the mover moves, and includes a drive unit, a thrust command generation unit, and a current command generation unit. The drive unit supplies drive currents to a plurality of coils disposed along the transfer path. The thrust command generation unit generates a thrust command that is the command value of a thrust to be produced by the mover, based on a motion target value that is a time-series motion target value input from outside or internally generated. The current command generation unit generates, as current commands, current target values that are the target values of the drive currents to be provided to the plurality of coils so that the thrust produced by the mover follows the thrust command. The current command generation unit generates the current target values to be provided to the plurality of coils, using part of an actual thrust characteristic determined by the characteristics of the plurality of coils and the mover, so as to reduce the number of the coils through which the drive currents flow.

### Effects of the Invention

The transfer system of the present disclosure has the advantages of being able to simplify a circuit configuration and allowing control by simple processing.

### BRIEF DESCRIPTION OF DRAWINGS

FIG. 1 is a diagram illustrating an exemplary configuration of a transfer system according to a first embodiment.

FIG. 2 is a diagram illustrating an exemplary configuration of a control device and a drive device according to the first embodiment.

FIG. 3 is a diagram for explaining a problem in the first embodiment.

FIG. 4 is a diagram for explaining a modified thrust coefficient distribution used in a current command generation unit of the first embodiment.

FIG. 5 is a diagram for explaining an effect when current commands are generated using the modified thrust coefficient distribution illustrated in FIG. 4.

FIG. 6 is a diagram illustrating an exemplary configuration of a control device according to a first modification of the first embodiment.

FIG. 7 is a diagram illustrating an exemplary configuration of a control device according to a second modification of the first embodiment.

FIG. 8 is a diagram for explaining a problem in a second embodiment.

FIG. 9 is a diagram for explaining the operation of a control device according to the second embodiment.

FIG. 10 is a diagram for explaining a problem in a third embodiment.

FIG. 11 is a diagram for explaining a modified thrust coefficient distribution used in a current command generation unit of the third embodiment.

FIG. 12 is a diagram for explaining the operation of a control device according to a fourth embodiment.

FIG. 13 is a block diagram illustrating an example of a hardware configuration that implements the functions of the control device and the drive device in the first to fourth embodiments.

FIG. 14 is a block diagram illustrating another example of a hardware configuration that implements the functions of the control device and the drive device in the first to fourth embodiments.

### DESCRIPTION OF EMBODIMENTS

Hereinafter, a transfer system and a control device according to embodiments of the present disclosure will be described in detail with reference to the accompanying drawings. In the following description, a plurality of components of the same type are denoted by a reference numeral with letters or figures added thereto. However, when the individual components are described without distinction, the notation of the letters or figures is omitted as appropriate.

### First Embodiment

A transfer system according to a first embodiment is a system used to transfer objects. The transfer system transfers objects by moving movers on which the objects are placed. The movers are, for example, carriages.

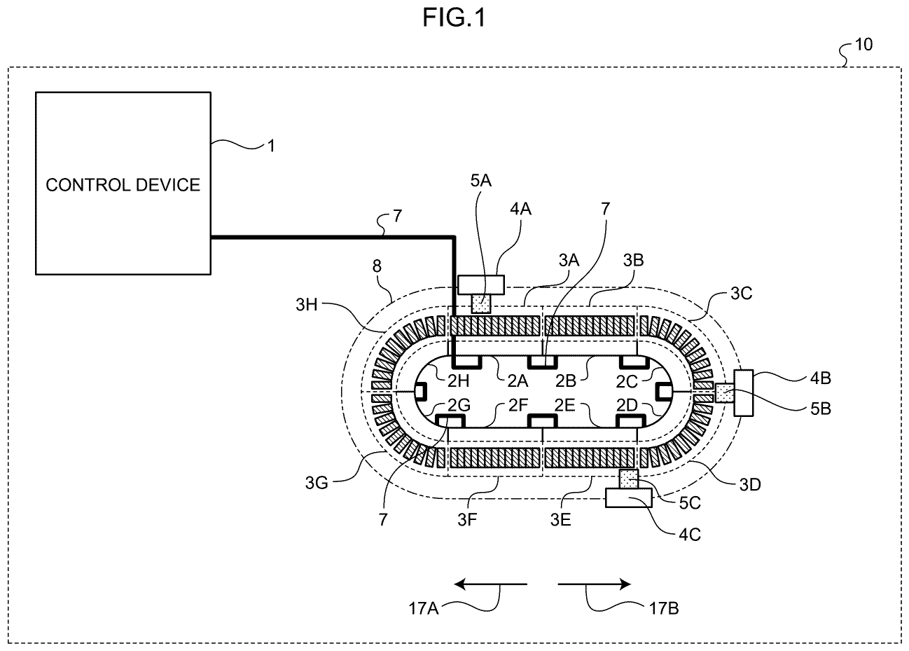

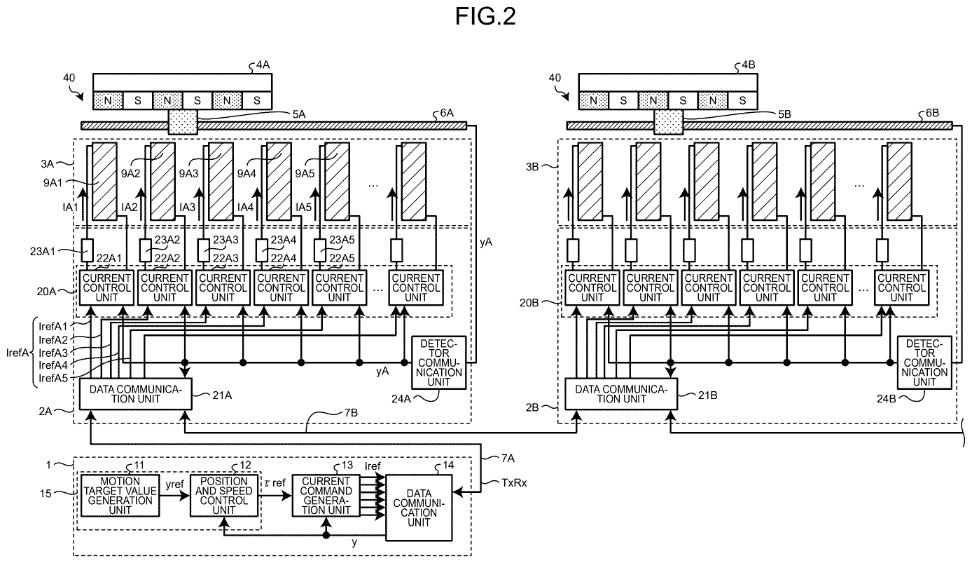

FIG. 1 is a diagram illustrating an exemplary configuration of a transfer system 10 according to the first embodiment. As illustrated in FIG. 1, the transfer system 10 of the first embodiment includes a control device 1, drive devices 2A, 2B, 2C, 2D, 2E, 2F, 2G, and 2H (hereinafter, denoted as “2A to 2H” as appropriate. Other reference numerals are denoted likewise), coil units 3A to 3H, movers 4A to 4C, and scale heads 5A to 5C. As illustrated in FIG. 2, the transfer system 10 of the first embodiment also includes linear scales 6A and 6B. Although not illustrated in FIG. 2, the drive devices 2C to 2H also include linear scales.

The drive devices 2 are connected to each other. In the transfer system 10, the drive devices 2 are connected to each other to form a transfer path 8 along which the movers 4 move. The drive devices 2 provide currents to the coil units 3 to produce thrusts on the movers 4 to move the movers 4.

FIG. 1 illustrates an annular closed path, but the present invention is not limited to this example. The transfer path 8 of the transfer system 10 may be an open path. That is, the transfer path 8 of the transfer system 10 may be a path having a starting point and an ending point.

The drive devices 2A, 2B, 2E, and 2F are linear drive devices 2 constituting linear paths. The drive devices 2C, 2D, 2G, and 2H are curved drive devices 2 constituting curved paths, and change the traveling direction of the movers 4. The transfer path 8 may consist of only the curved drive devices 2 without the linear drive devices 2. That is, the transfer path 8 may have any overall shape.

The transfer system 10 according to the first embodiment is a moving-magnet linear motor. The movers 4 move along a guide rail (not illustrated) provided on the side of the transfer path 8. The movers 4 include permanent magnets (not illustrated) and are attached to the side of the transfer path 8. The movers 4 include guide rollers (not illustrated) which move on the guide rail by rotation thereof. The movers 4 move on the side of the transfer path 8 and stop on the side of the transfer path 8. Note that guide rollers may be provided on the top of the transfer path 8.

The traveling direction of each mover 4 is a clockwise direction in FIG. 1 or a counterclockwise direction in FIG. 1. Of the traveling directions, the clockwise direction in FIG. 1 is referred to as a forward direction. Of the traveling directions, the counterclockwise direction in FIG. 1 is referred to as a reverse direction. An arrow 17A represents the forward direction, and an arrow 17B represents the reverse direction.

In the example illustrated in FIG. 1, the transfer system 10 includes the eight drive devices 2 and the three movers 4. The number of drive devices 2 included in the transfer system 10 is arbitrary. That is, the number of drive devices 2 constituting the transfer path 8 is arbitrary, and the number of movers 4 moving along the transfer path 8 is also arbitrary. The number of movers 4 moving along the transfer path 8 may be one.

The control device 1 is connected to the drive devices 2 via data communication lines 7. The control device 1 controls each of the drive devices 2. The data communication lines 7 include a communication line that connects the control device 1 and one of the drive devices 2, and communication lines that connect the drive devices 2 adjacent to each other. That is, the transfer system 10 has a configuration in which the control device 1 is connected to the drive devices 2 by a daisy-chain connection. Note that the connection topology between the control device 1 and the drive devices 2 is not limited to the daisy-chain connection. The connection topology between the control device 1 and the drive devices 2 may be a star connection in which each of the drive devices 2 is connected to the control device 1 via a communication hub. Alternatively, the transfer system 10 may include a plurality of data communication lines 7, and the control device 1 and each drive device 2 may be directly connected by the corresponding data communication line 7. The data communication lines 7 may be communication channels that allow wireless communication, instead of physical communication lines.

Next, with reference to FIG. 2, a configuration and functions of the control device 1 and the drive devices 2 will be described. FIG. 2 is a diagram illustrating an exemplary configuration of the control device 1 and the drive devices 2 according to the first embodiment.

On the upper left side of FIG. 2, the drive device 2A, the coil unit 3A, the mover 4A, the scale head 5A, and the linear scale 6A are illustrated. On the right side of FIG. 2, the drive device 2B, the coil unit 3B, the mover 4B, the scale head 5B, and the linear scale 6B are illustrated. On the lower left side of FIG. 2, the control device 1 is illustrated.

The drive device 2A includes a drive unit 20A, a data communication unit 21A, a detector communication unit 24A, and current detectors 23A. The drive unit 20A includes a plurality of current control units 22A. The coil unit 3A includes a plurality of coils 9A connected one-to-one to the current control units 22A of the drive unit 20A. As illustrated in FIG. 1, the plurality of coils 9A are disposed along the transfer path 8. As illustrated in FIG. 2, the plurality of coils 9A are single-phase coils. Like the drive device 2A, the drive device 2B includes a drive unit 20B, a data communication unit 21B, and a detector communication unit 24B.

The mover 4A includes permanent magnets 40. The permanent magnets 40 included in the mover 4A are permanent magnets that contribute to the drive of the mover 4A.

As described with reference to FIG. 1, the drive devices 2A, 2B, 2E, and 2F are all the linear drive devices 2. On the other hand, the drive devices 2C, 2D, 2G, and 2H are the curved drive devices 2. However, the configuration of the curved drive devices 2 is the same as that of the linear drive devices 2 except that the coils 9 are disposed in a different manner as compared with the linear drive devices 2. Therefore, the following description focuses on the drive device 2A, which is the linear drive device 2. Note that the contents described below are not limited to the linear drive devices 2.

In FIG. 2, five of the coils 9A in the coil unit 3A are denoted by reference numerals 9A1 to 9A5, and five of the current control units 22A in the drive unit 20A are denoted by reference numerals 22A1 to 22A5. Here, the five coils 9A denoted by the reference numerals 9A1 to 9A5 are the coils disposed in the range affected by the magnetic field emitted from the permanent magnets 40 included in the mover 4A, and are the coils that contribute to the drive of the mover 4A. The five current control units 22A denoted by the reference numerals 22A1 to 22A5 are the current control units connected to the coils 9A denoted by the reference numerals 9A1 to 9A5. When the positional relationship between the mover 4A and the coil unit 3A is as illustrated in FIG. 2, the coils 9A far from the mover 4A do not greatly contribute to the drive of the mover 4A. In the first embodiment, the coils 9A1 to 9A5 are described as the coils that contribute to the drive of the mover 4A. Then, drive currents are supplied to the coils 9A1 to 9A5 by the current control units 22A1 to 22A5 connected one-to-one to the coils 9A1 to 9A5. The number of the coils 9 contributing to the drive of one mover 4 is determined by the number of the coils 9 disposed in the range affected by the size, the magnetic field strength, etc. of the permanent magnets 40 of the mover 4. The number of the coils 9A that drive the mover 4A described here is an example, and the present invention is not limited to this example. That is, the number of the coils 9A that contribute to the drive of the mover 4A may be other than five.

The scale head 5A is attached to the mover 4A. The scale head 5A moves on the linear scale 6A together with the mover 4A. The linear scale 6A detects position information of the mover 4A and transmits the position information to the detector communication unit 24A of the drive device 2. Specifically, the linear scale 6 detects a motion detection value yA such as the position or speed of the mover 4A from the position of the scale head 5 connected to the mover 4A, and transmits the detected motion detection value yA to the detector communication unit 24A. The scale head 5A can be formed of, for example, a permanent magnet for position detection. The linear scale 6A can be formed of a sensor element that detects the magnetic field of the position detection magnet.

The control device 1 includes a motion target value generation unit 11, a position and speed control unit 12, a current command generation unit 13, and a data communication unit 14. The motion target value generation unit 11 and the position and speed control unit 12 constitute a thrust command generation unit 15.

The data communication unit 14 and the data communication unit 21A are connected by a communication line 7A. The data communication unit 21A and the data communication unit 21B are connected by a communication line 7B. This connection topology is the daisy-chain connection described above. Communication data TxRx transmitted and received by the data communication unit 14 and the data communication unit 21A includes not only information on the drive device 2A but also information on the drive devices 2B to 2H. The data communication unit 21A of the drive device 2A transmits the communication data TxRx received from the data communication unit 14 to the data communication unit 21B of the drive device 2B. Likewise, the data communication unit 21B transmits the received communication data TxRx to the next drive device 2C (not illustrated in FIG. 2).

The data communication unit 14 receives information on motion detection values y via the data communication unit 21A of the drive device 2A. The motion detection values y received by the data communication unit 14 include not only the motion detection value yA of the mover 4A but also the motion detection values of the movers 4B and 4C.

The thrust command generation unit 15 generates thrust commands tref that are the command values of thrusts to be produced by the movers 4, based on motion target values yref that are time-series motion target values generated by the motion target value generation unit 11, and the motion detection values y representing the moving positions or the moving speeds of the movers 4.

Specifically, the position and speed control unit 12 generates the thrust commands tref so that the motion detection values y follow the motion target values yref. Similarly to the motion detection values y, the motion target values yref include motion target values for all the movers 4A to 4C present in the transfer system 10. The thrust commands tref are generated for the respective movers 4 and include thrust commands for all the movers 4A to 4C. In FIG. 2, the motion target values yref are generated inside the control device 1, but the present invention is not limited to this configuration. The motion target values yref may be input to the control device 1 from outside.

The current command generation unit 13 generates, as current commands Iref, current target values that are the target values of drive currents to be provided to the plurality of coils 9, based on the thrust commands tref and the motion detection values y representing the moving positions or the moving speeds of the movers 4. A specific method of generating the current commands Iref will be described below. Information on the generated current commands Iref is transmitted to the data communication unit 21A by the data communication unit 14.

The data communication unit 21A of the drive device 2A extracts current commands IrefA1 to IrefA5 that are current commands for the drive device 2A from the communication data TxRx transmitted from the data communication unit 14, and outputs the extracted current commands IrefA1 to IrefA5 to the current control units 22A1 to 22A5. It goes without saying that the communication data TxRx transmitted from the data communication unit 14 includes the current commands Iref for the drive devices 2B to 2H.

Current detectors 23A1 to 23A5 detect currents IA1 to IA5 flowing through the coils 9A1 to 9A5. The current control units 22A1 to 22A5 acquire the current commands IrefA1 to IrefA5 from the data communication unit 21A, acquire the motion detection value yA from the detector communication unit 24A, and acquire the detection values of the currents IA1 to IA5 from the current detectors 23A1 to 23A5. The current control units 22A1 to 22A5 control the currents IA1 to IA5 that are the drive currents to be provided to the coils 9A1 to 9A5 so that the detection values of the currents IA1 to IA5 follow the current commands IrefA1 to IrefA5. Note that the currents IA1 to IA5 may be controlled with any method.

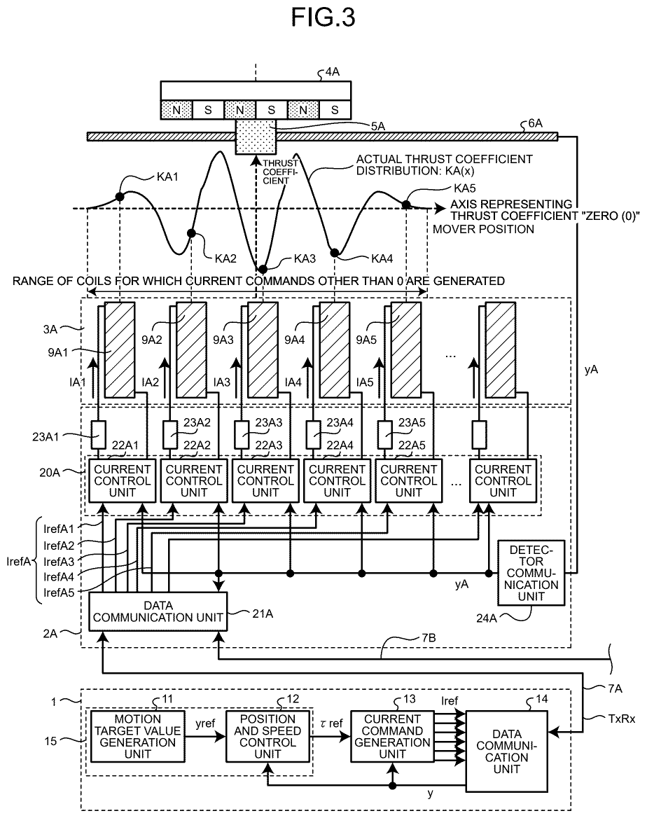

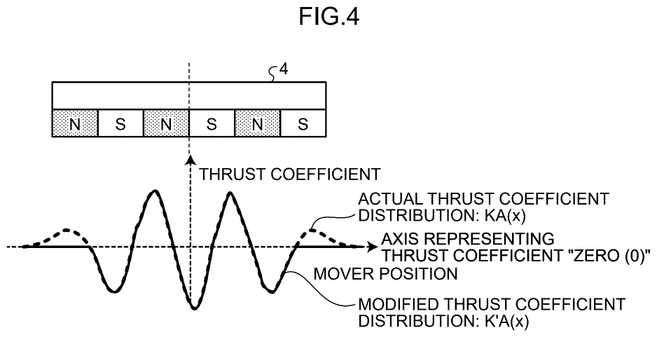

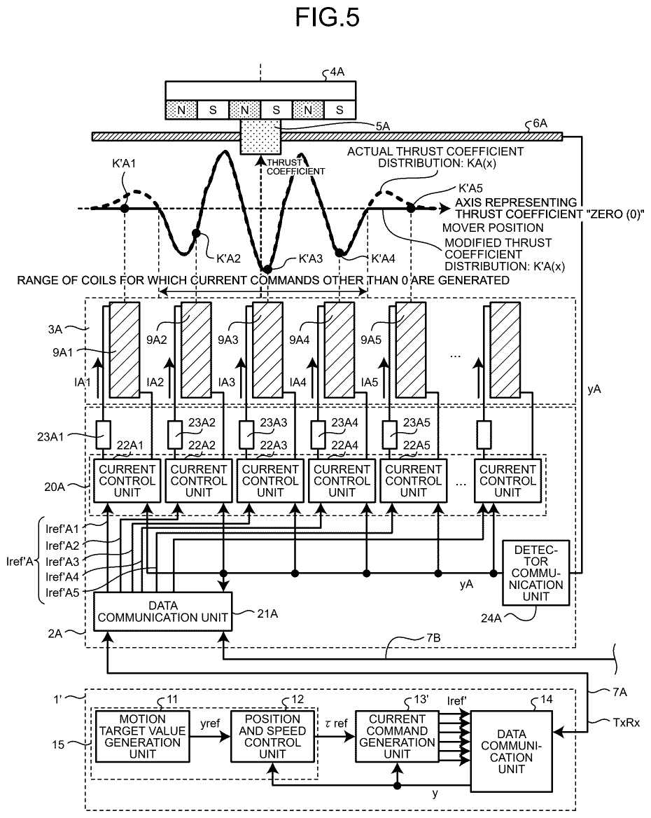

Next, with reference to the drawings of FIGS. 3 to 5, the detailed operation of the current command generation unit 13 included in the control device 1 according to the first embodiment will be described. FIG. 3 is a diagram for explaining a problem in the first embodiment. FIG. 4 is a diagram for explaining a modified thrust coefficient distribution used in the current command generation unit 13 of the first embodiment. FIG. 5 is a diagram for explaining an effect when the current commands Iref are generated using the modified thrust coefficient distribution illustrated in FIG. 4. FIGS. 3 and 5 are diagrams obtained by extracting the control device 1, the drive device 2A, the coil unit 3A, the mover 4A, the scale head 5A, and the linear scale 6A from FIG. 2, and components identical or equivalent to those in FIG. 2 are denoted by the same reference numerals. In the following description, portions overlapping the above-described contents will be omitted as appropriate.

As described above, the current command generation unit 13 generates the current commands IrefA, based on the thrust commands tref and the motion detection values y of the movers 4. Specifically, the current command generation unit 13 calculates the current commands IrefA1 to IrefA5, which are the target values of the drive currents to be provided to the coils 9A1 to 9A5, with formula (1) below. The current command generation unit 13 calculates the current commands Iref for the respective coils 9 of each coil unit 3 included in the transfer system 10. Here, for the sake of convenience, the calculation of the five current commands IrefA1 to IrefA5 will be described.

$$IrefA 1 = KA 1 / ( KA 1 \hat{} 2 + KA 2 \hat{} 2 + KA 3 \hat{} 2 + KA 4 \hat{} 2 + KA 5 \hat{} 2 ) \times τ ref \qquad formula ( 1 )$$

$$IrefA 2 = KA 2 / ( KA 1 \hat{} 2 + KA 2 \hat{} 2 + KA 3 \hat{} 2 + KA 4 \hat{} 2 + KA 5 \hat{} 2 ) \times τ ref$$

$$IrefA 3 = KA 3 / ( KA 1 \hat{} 2 + KA 2 \hat{} 2 + KA 3 \hat{} 2 + KA 4 \hat{} 2 + KA 5 \hat{} 2 ) \times τ ref$$

$$IrefA 4 = KA 4 / ( KA 1 \hat{} 2 + KA 2 \hat{} 2 + KA 3 \hat{} 2 + KA 4 \hat{} 2 + KA 5 \hat{} 2 ) \times τ ref$$

$$IrefA 5 = KA 5 / ( KA 1 \hat{} 2 + KA 2 \hat{} 2 + KA 3 \hat{} 2 + KA 4 \hat{} 2 + KA 5 \hat{} 2 ) \times τ ref$$

In formula (1), KA1 to KA5 are coefficients representing the magnitudes of thrusts produced with respect to the currents IA1 to IA5 flowing through the coils 9A1 to 9A5. In this description, the coefficients are referred to as “thrust coefficients”.

Here, FIG. 3 illustrates the waveform of an actual thrust coefficient distribution KA(x). The actual thrust coefficient distribution KA(x) is a waveform representing the relationship between the mover position representing the distance from the center position of the mover 4 and the thrust coefficients. The horizontal axis of the graph showing the waveform of the actual thrust coefficient distribution KA(x) represents the position of the mover, and is an axis that coincides with the thrust coefficient “0 (zero)”. The same applies to the following drawings. The thrust coefficients KA1 to KA5 in formula (1) above can be determined from the actual thrust coefficient distribution KA(x) illustrated in FIG. 3. The actual thrust coefficient distribution KA(x) is an actual thrust characteristic determined by the characteristics of the coils 9 and the mover 4. Here, the characteristics of the coils 9 for determining the actual thrust characteristic include the number of windings of the coils 9, the radius of the coil windings, etc., and the characteristics of the mover 4 include the magnetic flux, the magnetic pole pitch, etc. of the permanent magnets 40 included in the mover 4.

The thrust coefficients KA1 to KA5 in the actual thrust coefficient distribution KA(x) have the same values as induced voltage coefficients representing the relationships between the mover position and the induced voltages produced in the coils 9A1 to 9A5 when the mover 4 moves. Therefore, this description uses the actual thrust coefficient distribution KA(x) created using the induced voltages produced in the coils 9A1 to 9A5 when the mover 4 moves.

According to the equations in formula (1), when the thrust coefficients KA1 to KA5 are zero, the current commands IrefA of 0 [A] are generated. The current commands IrefA of 0 [A] are input to the current control units 22A via the data communication units 14 and 21A. The current control units 22A control the currents flowing through the coils 9A to 0 [A]. Consequently, no drive currents flow through the coils 9A to which the current commands IrefA of 0 [A] are provided.

On the other hand, when the thrust coefficients KA1 to KA5 are not zero, the current commands IrefA that are not 0 [A] are generated. The current commands IrefA that are not 0 [A] are input to the current control units 22A via the data communication units 14 and 21A. The current control units 22A control the currents flowing through the coils 9A to values other than 0 [A]. Consequently, the drive currents flow through the coils 9A to which the current commands IrefA that are not 0 [A] are provided.

As can be understood from the above description, when the equations in formula (1) are used, the drive currents to be passed through the coils 9A depend on the actual thrust coefficient distribution KA(x) of the mover 4. Consequently, when the actual thrust coefficient distribution KA(x) illustrated in FIG. 3 is used, the number of coils through which drive currents flow cannot be changed as desired.

Therefore, in the first embodiment, a modified thrust coefficient distribution K′A(x) illustrated in FIG. 4 is used instead of the actual thrust coefficient distribution KA(x) illustrated in FIG. 3. In FIG. 4, the actual thrust coefficient distribution KA(x) illustrated in FIG. 3 is indicated by a broken line, and the modified thrust coefficient distribution K′A(x) is indicated by a solid line. FIG. 5 illustrates an exemplary configuration of a control device 1′ using the modified thrust coefficient distribution K′A(x). In FIG. 5, the current command generation unit 13 illustrated in FIG. 3 is replaced with a current command generation unit 13′. Furthermore, in FIG. 5, the current commands IrefA (IrefA1 to IrefA5) input to the current control units 22A are changed to current commands Iref′A (Iref′A1 to Iref′A5). That is, the current command generation unit 13′ generates the current commands Iref′A that are the current target values, using part of the actual thrust characteristic determined by the characteristics of the coils 9 and the mover 4. In FIG. 5, parts identical or equivalent to those in FIG. 3 are denoted by the same reference numerals, and redundant descriptions are omitted as appropriate.

$${Iref}^{′} A 1 = {K}^{′} A 1 / ( {K}^{′} A 1 \hat{} 2 + {K}^{′} A 2 \hat{} 2 + {K}^{′} A 3 \hat{} 2 + {K}^{′} A 4 \hat{} 2 + {K}^{′} A 5 \hat{} 2 ) \times τ ref \qquad formula ( 2 )$$

$${Iref}^{′} A 2 = {K}^{′} A 2 / ( {K}^{′} A 1 \hat{} 2 + {K}^{′} A 2 \hat{} 2 + {K}^{′} A 3 \hat{} 2 + {K}^{′} A 4 \hat{} 2 + {K}^{′} A 5 \hat{} 2 ) \times τ ref$$

$${Iref}^{′} A 3 = {K}^{′} A 3 / ( {K}^{′} A 1 \hat{} 2 + {K}^{′} A 2 \hat{} 2 + {K}^{′} A 3 \hat{} 2 + {K}^{′} A 4 \hat{} 2 + {K}^{′} A 5 \hat{} 2 ) \times τ ref$$

$${Iref}^{′} A 4 = {K}^{′} A 4 / ( {K}^{′} A 1 \hat{} 2 + {K}^{′} A 2 \hat{} 2 + {K}^{′} A 3 \hat{} 2 + {K}^{′} A 4 \hat{} 2 + {K}^{′} A 5 \hat{} 2 ) \times τ ref$$

$${Iref}^{′} A 5 = {K}^{′} A 5 / ( {K}^{′} A 1 \hat{} 2 + {K}^{′} A 2 \hat{} 2 + {K}^{′} A 3 \hat{} 2 + {K}^{′} A 4 \hat{} 2 + {K}^{′} A 5 \hat{} 2 ) \times τ ref$$

In formula (2), K′A1 to K′A5 are thrust coefficients determined from the modified thrust coefficient distribution K′A(x). The modified thrust coefficient distribution K′A(x) is a waveform representing a modified thrust characteristic created using part of the actual thrust coefficient distribution KA(x), which is the actual thrust characteristic determined by the characteristics of the plurality of coils 9 and the mover 4. In FIG. 5, the modified thrust coefficient distribution K′A(x) is created by cutting out part of the actual thrust coefficient distribution KA(x) determined by the characteristics of the coils 9A1 to 9A5 and the mover 4A.

Specifically, in the modified thrust coefficient distribution K′A(x) of FIG. 5, the value of the thrust coefficient K′A1 corresponding to the coil 9A1 and the value of the thrust coefficient K′A5 corresponding to the coil 9A5 are “0”. Consequently, the current command Iref′A1 that is the target value of the drive current to be provided to the coil 9A1, and the current command Iref′A5 that is the target value of the drive current to be provided to the coil 9A5 are current commands of 0 [A] when calculated using formula (2). Thus, the number of the coils 9A through which the drive currents are passed changes from five to three, and the number of the coils 9A through which the drive currents are passed is reduced.

Note that the modified thrust coefficient distribution K′A(x) illustrated in FIGS. 4 and 5 is an example, and is not limited to the waveform illustrated in these figures.

As described above, using the control device 1′ according to the first embodiment allows a reduction in the number of coils through which to pass drive currents without connecting switches to the plurality of coils 9 as in Patent Literature 1.

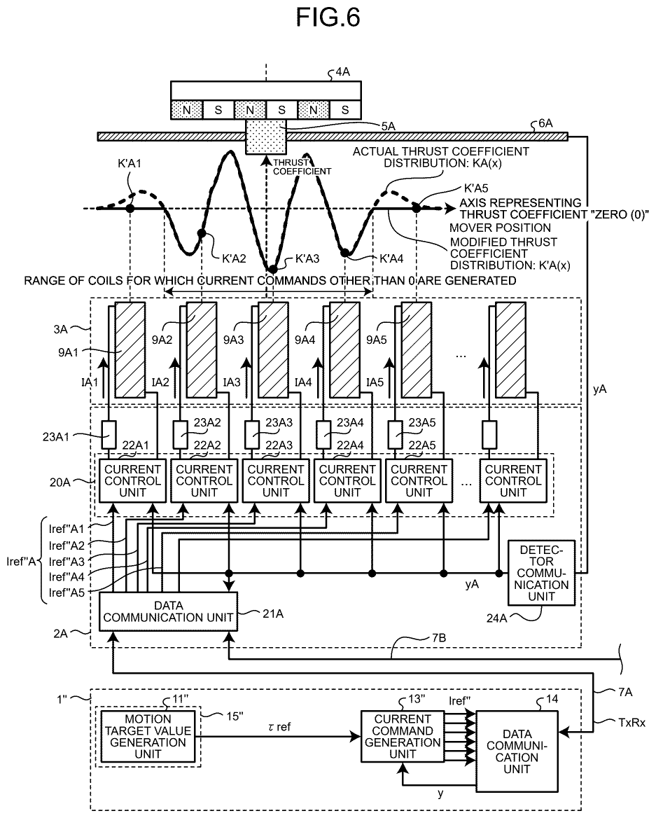

Next, modifications of the configuration of the control device 1′ according to the first embodiment will be described. FIG. 6 is a diagram illustrating an exemplary configuration of a control device 1″ according to a first modification of the first embodiment. In FIG. 6, the thrust command generation unit 15 illustrated in FIG. 5 is replaced with a thrust command generation unit 15″, the motion target value generation unit 11 illustrated in FIG. 5 is replaced with a motion target value generation unit 11″, and the current command generation unit 13′ illustrated in FIG. 5 is replaced with a current command generation unit 13″. In FIG. 6, the position and speed control unit 12 present in FIG. 5 is omitted. In FIG. 6, parts identical or equivalent to those in FIG. 5 are denoted by the same reference numerals, and redundant descriptions are omitted as appropriate.

In FIG. 6, in the case where the motion target values yref generated by the motion target value generation unit 11″ can be regarded as the thrust commands tref, the motion target value generation unit 11 can be configured as the thrust command generation unit 15″ as illustrated in FIG. 6, and the thrust commands tref output from the thrust command generation unit 15″ can be input to the current command generation unit 13″. The current command generation unit 13″ generates current commands Iref″ using the thrust commands tref and outputs the current commands Iref″ to the data communication unit 14. Current commands Iref″A (Iref″A1 to Iref″A5) are input to the current control units 22A via the data communication units 14 and 21A. The current control units 22A control the currents IA1 to IA5, which are the drive currents to be provided to the coils 9A1 to 9A5, so that the detection values of the currents IA1 to IA5 follow Iref″A1 to Iref″A5.

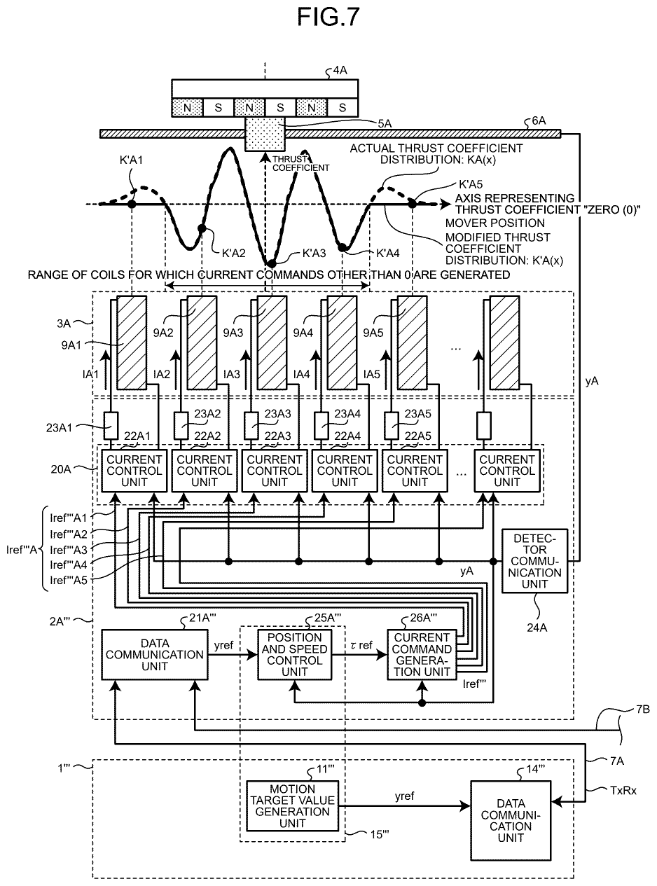

The control device 1′ according to the first embodiment may be configured as illustrated in FIG. 7. FIG. 7 is a diagram illustrating an exemplary configuration of a control device 1′″ according to a second modification of the first embodiment. In FIG. 7, the thrust command generation unit 15 illustrated in FIG. 5 is replaced with a thrust command generation unit 15′″. The position and speed control unit 12 and the current command generation unit 13′ illustrated in FIG. 5 are moved to the drive device 2A in FIG. 7, and are configured as a position and speed control unit 25A′″ and a current command generation unit 26A′″. In FIG. 7, the motion target value generation unit 11 illustrated in FIG. 5 is replaced with a motion target value generation unit 11′″. That is, in FIG. 7, the motion target value generation unit 11′″ and the position and speed control unit 25A′″ that are components of the thrust command generation unit 15′″ are separately disposed in the control device 1′″ and the drive device 2A″″, respectively. Further, in FIG. 7, the data communication unit 14 illustrated in FIG. 5 is replaced with a data communication unit 14′″, and the data communication unit 21A illustrated in FIG. 5 is replaced with a data communication unit 21A′″. In FIG. 7, parts identical or equivalent to those in FIG. 5 are denoted by the same reference numerals, and redundant descriptions are omitted as appropriate.

In FIG. 7, the motion target values yref generated by the motion target value generation unit 11′″ are output to the data communication unit 14 to be transmitted to the drive device 2A. The position and speed control unit 25A′″ receives information on the motion target value yref via the data communication unit 21A′″. The position and speed control unit 25A′″ generates the thrust command tref so that the motion detection value y follows the motion target value yref, and outputs the thrust command tref to the current command generation unit 26A′″. The current command generation unit 26A′″ generates current commands Iref′″A (Iref′″A1 to Iref′″A5) based on the thrust command tref and the motion detection value yA of the mover 4A, and outputs the current commands Iref′″A (Iref′″A1 to Iref′″A5) to the current control units 22A. The current control units 22A control the currents IA1 to IA5, which are the drive currents to be provided to the coils 9A1 to 9A5, so that the detection values of the currents IA1 to IA5 follow the current commands Iref′″A1 to Iref′″A5.

As described above, the transfer system according to the first embodiment is a transfer system including a mover and a transfer path along which the mover moves. The transfer system includes a drive unit that supplies drive currents to a plurality of coils disposed along the transfer path, and a thrust command generation unit that generates a thrust command that is the command value of a thrust to be produced by the mover, based on a motion target value that is a time-series motion target value input from outside or internally generated. The transfer system also includes a current command generation unit that generates, as current commands, current target values that are the target values of drive currents to be provided to the plurality of coils so that the thrust produced by the mover follows the thrust command. The current command generation unit generates the current target values to be provided to the plurality of coils, using part of an actual thrust characteristic determined by the characteristics of the plurality of coils and the mover, so as to reduce the number of the coils through which the drive currents flow. The transfer system configured like this allows a reduction in the number of the coils through which to pass the drive currents without connecting switches to the plurality of coils as in Patent Literature 1. This can provide a transfer system that can simplifies a circuit configuration and allows control by simple processing.

The control device according to the first embodiment is a control device configured to be applicable to a transfer system including a mover, a transfer path along which the mover moves, and a drive device that supplies drive currents to a plurality of coils disposed along the transfer path. The control device includes a thrust command generation unit that generates a thrust command that is the command value of a thrust to be produced by the mover, based on a motion target value that is a time-series motion target value input from outside or internally generated. The control device also includes a current command generation unit that generates, as current commands, current target values that are the target values of the drive currents to be provided to the plurality of coils so that the thrust produced by the mover follows the thrust command. The current command generation unit generates the current target values to be provided to the plurality of coils, using part of an actual thrust characteristic determined by the characteristics of the plurality of coils and the mover, so as to reduce the number of the coils through which the drive currents flow. The control device configured like this allows a reduction in the number of the coils through which to pass the drive currents without connecting switches to the plurality of coils as in Patent Literature 1. This can provide a control device that can simplify a circuit configuration and allows control by simple processing.

### Second Embodiment

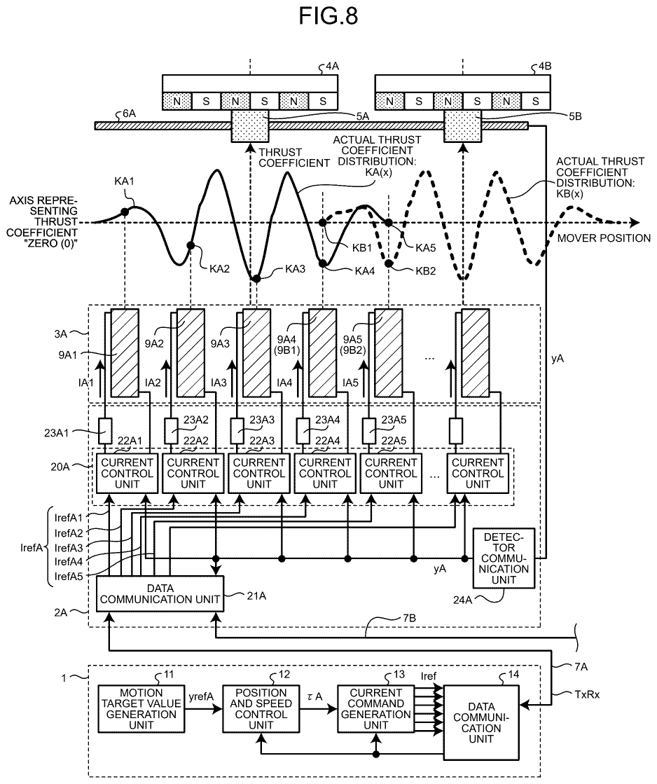

In a second embodiment, a transfer system and a control device capable of solving another problem while solving the problem in the first embodiment will be described. FIG. 8 is a diagram for explaining the problem in the second embodiment. In FIG. 8, components identical or equivalent to those in FIG. 3 are denoted by the same reference numerals. In the following description, portions overlapping the above-described contents will be omitted as appropriate.

FIG. 8 illustrates a situation in which the movers 4 are adjacent to each other on the linear scale 6A, and illustrates the mover 4A and the adjacent mover 4B. In FIG. 8, the waveform of the actual thrust coefficient distribution KA(x) using the characteristics of the mover 4A is indicated by a solid line, and the waveform of an actual thrust coefficient distribution KB(x) using the characteristics of the mover 4B is indicated by a broken line. The actual thrust coefficient distribution KA(x) is used to generate the current commands Iref to the coils 9 through which to pass the drive currents to drive the mover 4A. The actual thrust coefficient distribution KB(x) is used to generate the current commands Iref to the coils 9 through which to pass the drive currents to drive the mover 4B.

As illustrated in FIG. 8, when the mover 4A is adjacent to the mover 4B, the coils 9 to drive the movers 4A and 4B are also adjacent to each other. That is, the plurality of coils 9A (a “first coil group” to be described below) to drive the mover 4A is adjacent to a plurality of coils 9B (a “second coil group” to be described below) to drive the mover 4B. In this description, the term “adjacent” refers to a situation as illustrated in FIG. 8 in which the right-side coils 9A4 and 9A5 of the coils 9A1 to 9A5, which are a coil group to drive the mover 4A as one mover, coincide with left-side coils 9B1 and 9B2 of coils of coils 9B1 to 9B5 (the coils 9B3 to 9B5 are not illustrated), which are a coil group to drive the mover 4B as the other mover. In this case, the thrust coefficients KA4 and KA5 used to generate the current commands IrefA4 and IrefA5 to the coils 9A4 and 9A5 to drive the mover 4A coincide with thrust coefficients KB1 and KB2 used to generate current commands IrefB1 and IrefB2 to the coils 9B1 and 9B2 to drive the mover 4B. Therefore, this situation may be regarded as adjacent.

In this description, any one of the plurality of movers 4 is sometimes referred to as a “first mover”, and a coil group consisting of the plurality of coils 9 that drive the first mover is sometimes referred to as a “first coil group”. The mover 4 adjacent to the first mover is sometimes referred to as a “second mover”, and a coil group consisting of the plurality of coils 9 that drive the second mover is sometimes referred to as a “second coil group”.

Specifically, the current command IrefA5 to the coil 9A4 and the current command IrefB2 to the coil 9B1 that is the same coil as the coil 9A4 can be expressed as in formulas (3) and (4) below, using formula (1) above.

$$IrefA 5 = KA 5 / ( KA 1 \hat{} 2 + KA 2 \hat{} 2 + KA 3 \hat{} 2 + KA 4 \hat{} 2 + KA 5 \hat{} 2 ) \times τ refA \qquad formula ( 3 )$$

$$IrefB 2 = KB 2 / ( KB 1 \hat{} 2 + KB 2 \hat{} 2 + KB 3 \hat{} 2 + KB 4 \hat{} 2 + KB 5 \hat{} 2 ) \times τ refB \qquad formula ( 4 )$$

In formulas (3) and (4) above, trefA is a thrust command to the mover 4A, and trefB is a thrust command to the mover 4B. Since the thrust commands trefA and trefB change with time, the current command IrefA5 to the coil 9A5 and the current command IrefB2 to the coil 9B2 that coincides with the coil 9A5 do not always match. When these current commands IrefA5 and IrefB2 do not match, if the current command IrefA5 calculated from formula (3) is input to the current control unit 22A5 to pass the drive current through the coil 9A5 (9B2), the thrust produced on the mover 4B does not match the thrust command trefB. Further, if the current command IrefB2 calculated from formula (4) is input to the current control unit 22A5, the thrust produced on the mover 4A does not match the thrust command trefA. Thus, in the case where the current commands Iref are calculated using the actual thrust coefficient distributions KA(x) and KB(x), when the movers 4 are adjacent to each other, there is a possibility that a thrust cannot be produced according to the thrust command tref on any one of the movers 4, causing a problem that it is difficult to control all the movers with high accuracy.

To solve this problem, in the second embodiment, the control device 1′ described in the first embodiment is used, and the movers 4 are driven using the modified thrust coefficient distribution K′A(x) presented in the first embodiment.

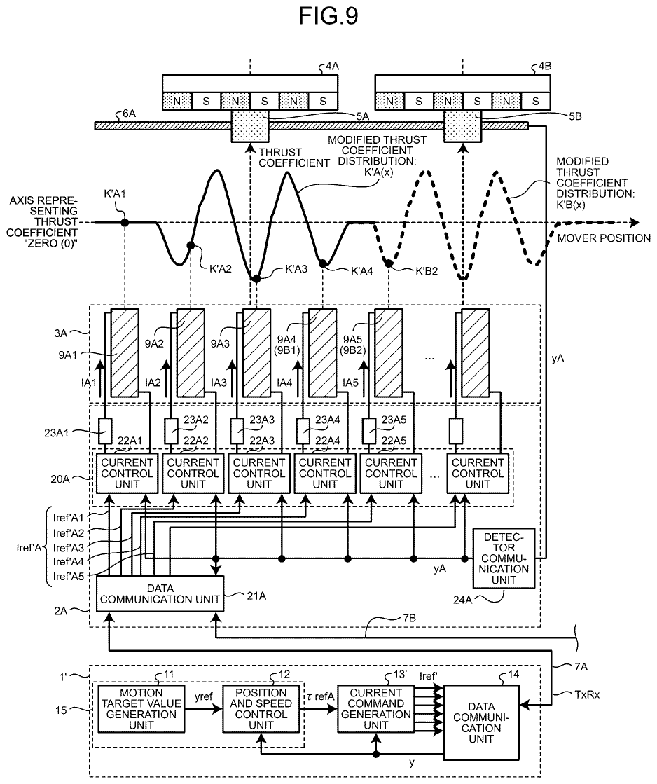

Next, an operation performed by the control device 1′ according to the second embodiment will be described. FIG. 9 is a diagram for explaining the operation of the control device 1′ according to the second embodiment. In FIG. 9, components identical or equivalent to those in FIG. 5 are denoted by the same reference numerals. In the following description, portions overlapping the above-described contents will be omitted as appropriate.

In FIG. 9, the waveform of the modified thrust coefficient distribution K′A(x) is indicated by a solid line, and the waveform of a modified thrust coefficient distribution K′B(x) is indicated by a broken line. The modified thrust coefficient distribution K′A(x) is used to generate the current commands Iref to the coils 9 through which to pass the drive currents to drive the mover 4A. The modified thrust coefficient distribution K′B(x) is used to generate the current commands Iref to the coils 9 through which to pass the drive currents to drive the mover 4B.

As illustrated in FIG. 9, when the mover 4A is adjacent to the mover 4B, the coils 9 driving the movers 4A and 4B are also adjacent to each other. On the other hand, using the modified thrust coefficient distributions K′A(x) and K′B(x) eliminates cases where both the value of a thrust coefficient K′A in the modified thrust coefficient distribution K′A(x) and the value of a thrust coefficient K′B in the modified thrust coefficient distribution K′B(x) do not become zero. In other words, at least one of the value of the thrust coefficient K′A in the modified thrust coefficient distribution K′A(x) and the value of the thrust coefficient K′B in the modified thrust coefficient distribution K′B(x) always becomes zero. Consequently, even in a situation where the movers 4A and 4B are adjacent to each other, the proper thrust commands tref can be provided to the movers 4A and 4B, so that the movers 4A and 4B can be controlled with high accuracy.

In FIG. 9, the case where the two movers 4A and 4B are adjacent to each other has been described, but the present invention is not limited to this example. The same description can be applied to the case where the movers 4B and 4C are adjacent to each other, and the case where the movers 4A and 4C are adjacent to each other. In FIG. 9, the case where the two movers 4A and 4B are adjacent to each other has been described. However, the same description can be applied to the case where three or more of the movers 4 are adjacent to each other.

By using the method of the second embodiment, the current commands Iref′ can be always calculated using formula (2) and the modified thrust coefficient distributions K′A(x) and K′B(x), regardless of situations where two or more of the movers 4 are adjacent to each other. Therefore, using the method of the second embodiment allows the current commands Iref′ to be calculated only with simple four arithmetic operations, and eliminates the need for complicated calculations such as simultaneous equations. This can provide the effect that the amount of calculation can be reduced to reduce the operation load.

Furthermore, in the method of the second embodiment, the current commands Iref′ can be calculated for all the movers 4, using formula (2) that is the same equations, so that modified thrust coefficient distributions K′(x) can be set to the same values for all the movers 4. Consequently, the thrust commands generated for all the movers 4 have the same value, so that the effect can obtained that the same control can be performed on all the movers 4.

As described above, in the transfer system and the control device according to the second embodiment, the current command generation unit generates the current target values to be provided to the coils of the first coil group, using part of the actual thrust characteristic determined by the characteristics of the coils of the first coil group and the first mover to be driven by the first coil group. The current command generation unit generates the current target values to be provided to the coils of the second coil group, using part of the actual thrust characteristic determined by the characteristics of the coils of the second coil group and the second mover to be driven by the second coil group. Here, the first coil group is the coil group consisting of the plurality of coils to drive the first mover, and the second coil group is the coil group consisting of the plurality of coils to drive the second mover and adjacent to the first coil group. By using modified thrust coefficient distributions created using not all of the actual thrust characteristics but part of the actual thrust characteristics, it can be avoided that different thrust commands are provided to the same coil that can control different movers in a situation where the movers are adjacent to each other. Consequently, even in a situation where two or more movers are adjacent to each other, proper thrust commands are provided to these movers, so that the two or more movers can be controlled with high accuracy without connecting switches to the plurality of coils.

In the second embodiment, the operation and its effects in the case of using the control device 1′ and the drive device 2A illustrated in FIG. 5 have been described. However, the operation using the control device 1″ and the drive device 2A illustrated in FIG. 6 can also provide the effects obtained in the second embodiment. Furthermore, the operation using the control device 1′″ and the drive device 2A′″ illustrated in FIG. 7 can also provide the effects obtained in the second embodiment.

### Third Embodiment

A third embodiment describes a method of generating a modified thrust coefficient distribution K′″A(x) used when the transfer system 10 according to the third embodiment calculates the current commands Iref′″.

First, the modified thrust coefficient distribution K′A(x) described in the first embodiment only needs to be a waveform obtained by cutting out part of the actual thrust coefficient distribution KA(x), and thus can be said to have a high degree of freedom in creation. On the other hand, if the modified thrust coefficient distribution K′A(x) created is improper, there is a problem that the mover 4 cannot be controlled with high accuracy. The third embodiment presents a method of generating the modified thrust coefficient distribution K′″A(x) that can address this problem.

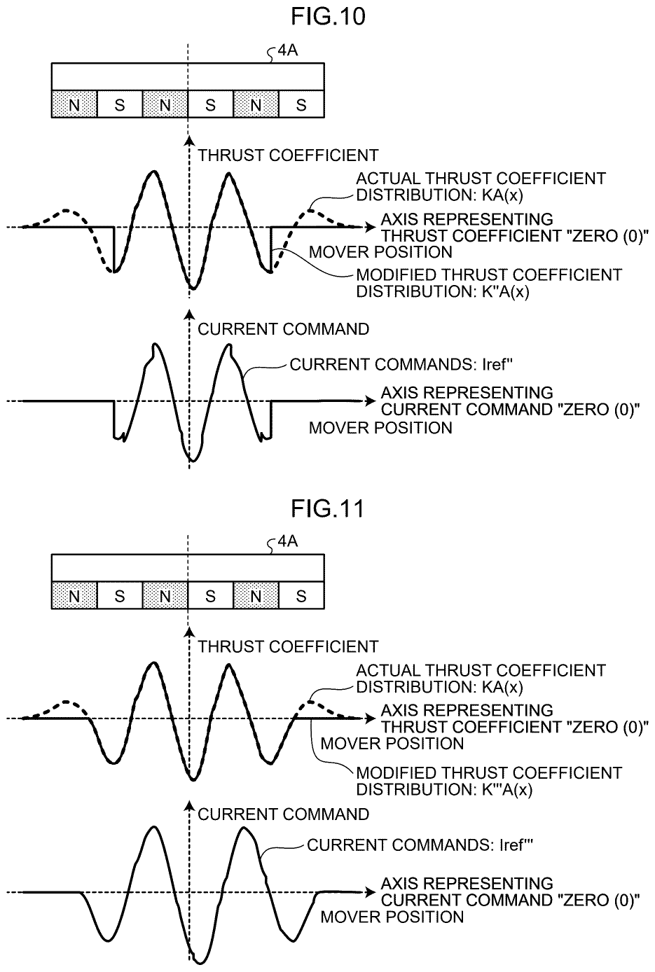

FIG. 10 is a diagram for explaining the problem in the third embodiment. In FIG. 10, the actual thrust coefficient distribution KA(x) illustrated in FIG. 3 is indicated by a broken line, and a modified thrust coefficient distribution K″A(x) generated using the actual thrust coefficient distribution KA(x) is indicated by a solid line. The modified thrust coefficient distribution K″A(x) illustrated in FIG. 10 is an example of an improper modified thrust coefficient distribution. In FIG. 10, the horizontal axis of the graph showing the waveform of the current commands Iref″ represents the position of the mover, and is an axis that coincides with the current command “0 (zero)”. The same applies to the following drawings.

Although the modified thrust coefficient distribution K″A(x) illustrated in FIG. 10 is created using the actual thrust coefficient distribution KA(x), the values of the thrust coefficients change discontinuously and steeply. Consequently, the current commands Iref″ generated using the modified thrust coefficient distribution K″A(x) also change discontinuously and steeply. On the other hand, even if these current commands Iref′ are provided to the coils 9, it is difficult to steeply change the currents IA flowing through the coils 9 due to the inductances of the coils 9. Consequently, the errors between the currents IA flowing through the coils 9 and the current commands Iref″ increase, and it becomes difficult to control the plurality of movers 4 with high accuracy.

FIG. 11 is a diagram for explaining a modified thrust coefficient distribution used in the current command generation unit 13′ of the third embodiment. The explanation here uses the control device 1′ and the drive device 2A illustrated in FIG. 5 or 10.

In FIG. 11, the actual thrust coefficient distribution KA(x) illustrated in FIG. 3 is indicated by a broken line, and the modified thrust coefficient distribution K′″A(x) generated using the actual thrust coefficient distribution KA(x) is indicated by a solid line. The modified thrust coefficient distribution K′″A(x) illustrated in FIG. 11 is an example of a proper modified thrust coefficient distribution.

FIG. 11 illustrates an example in which part of the actual thrust coefficient distribution KA(x) is cut out to be used for creation so that the values of the thrust coefficients become continuous. The term “continuous” used here means that the values of the thrust coefficients in the newly created modified thrust coefficient distribution K′″A(x) do not deviate from the values of the actual thrust characteristic determined by the actual thrust coefficient distribution KA(x). In the example of FIG. 11, in portions where the values of the thrust coefficients are different between the actual thrust coefficient distribution KA(x) and the modified thrust coefficient distribution K′″A(x), the values of the thrust coefficients in the modified thrust coefficient distribution K′″A(x) are zero. Setting the values of the thrust coefficients in the modified thrust coefficient distribution K′″A(x) to zero starts from the points at which the actual thrust coefficient distribution KA(x) crosses zero. Consequently, the current commands Iref′″ generated using the modified thrust coefficient distribution K′″A(x) change continuously and smoothly unlike in the case of FIG. 10. Therefore, even when the currents flowing through the coils 9 are controlled using the current commands Iref′″ generated using the modified thrust coefficient distribution K′ ‘′A(x), the errors between the currents IA flowing through the coils 9 and the current commands Iref’″ can be reduced, and the plurality of movers 4 can be controlled with high accuracy.

As described above, in the transfer system and the control device according to the third embodiment, the current command generation unit generates the current commands using the thrust coefficients having values that do not deviate from the values of the actual thrust characteristic determined by the characteristics of the plurality of coils and the mover. Consequently, the errors between the currents flowing through the coils and the current commands can be reduced, and the plurality of movers can be controlled with high accuracy.

The third embodiment has described the operation and its effect in the case of using the control device 1′ and the drive device 2A illustrated in FIG. 5 or 10. However, the operation may be performed using the control device 1″ and the drive device 2A illustrated in FIG. 6, or may be performed using the control device 1′″ and the drive device 2A′″ illustrated in FIG. 7. This can provide the effects obtained in the first and second embodiments and the effect obtained in the third embodiment.

### Fourth Embodiment

The first embodiment has described the method of generating the current commands Iref′ using the modified thrust coefficient distribution K′A(x) created using part of the actual thrust characteristic determined by the characteristics of the plurality of coils and the mover, and further using formula (2) above. A fourth embodiment describes a method of generating current commands Iref″″ using equations different from those in the first embodiment.

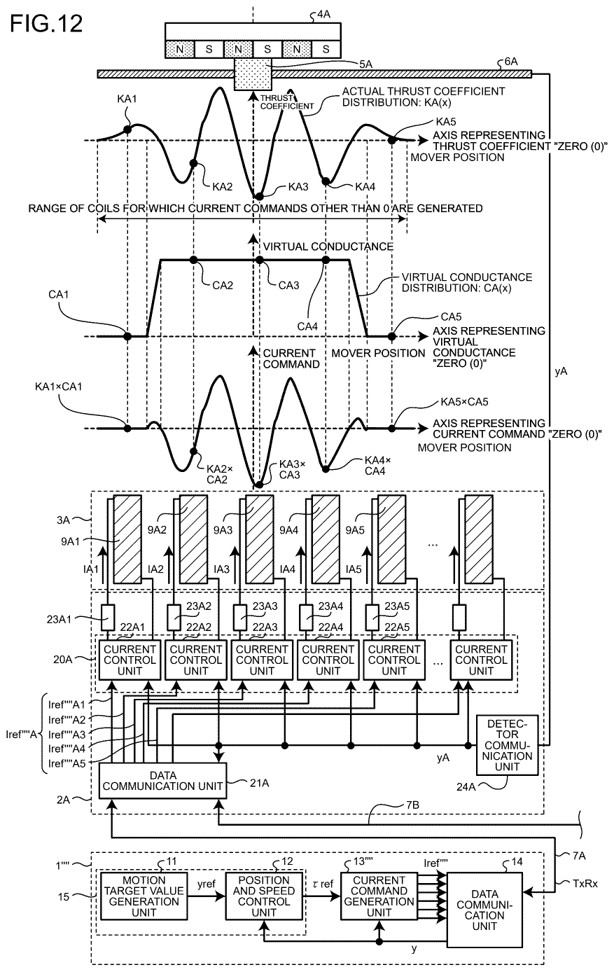

FIG. 12 is a diagram for explaining the operation of a control device 1″″ according to the fourth embodiment. In FIG. 12, the current command generation unit 13′ illustrated in FIG. 5 is replaced with a current command generation unit 13″″. FIG. 12 illustrates the same actual thrust coefficient distribution KA(x) as FIG. 3. FIG. 12 also illustrates a virtual conductance distribution CA(x). The horizontal axis of the graph showing the waveform of the virtual conductance CA(x) represents the position of the mover and is an axis that coincides with the virtual conductance “0 (zero)”. Further, FIG. 12 illustrates the waveform of the current commands determined from the product of the actual thrust coefficient distribution KA(x) and the virtual conductance distribution CA(x). The waveform of the current commands is a waveform representing the relationship between the mover position representing the distance from the center position of the mover 4 and the current commands. The virtual conductance distribution CA(x) is a waveform representing the relationship between the mover position representing the distance from the center position of the mover 4 and virtual conductance. The virtual conductance is a correction coefficient that varies according to the mover position. In FIG. 12, parts identical or equivalent to those in FIG. 5 are denoted by the same reference numerals, and redundant descriptions are omitted as appropriate.

Next, a method of generating the current commands Iref″″ in the fourth embodiment will be described. The following describes the generation method using the actual thrust coefficient distribution KA(x) illustrated in FIG. 3. However, the modified thrust coefficient distribution K′A(x) illustrated in FIGS. 4 and 5 may be used, or the modified thrust coefficient distribution K′″A(x) illustrated in FIG. 11 may be used.

The current command generation unit 13″″ generates, as the current commands Iref″″, current target values that are the target values of the drive currents to be provided to the plurality of coils 9, based on the thrust commands tref and the motion detection values y representing the moving positions or the moving speeds of the movers 4. Specifically, the current command generation unit 13″″ calculates current commands Iref″″A1 to Iref″″A5 that are the target values of the drive currents to be provided to the coils 9A1 to 9A5 with formula (5) below. Note that the current command generation unit 13″″ calculates the current commands Iref″″ for the respective coils 9 of each coil unit 3 included in the transfer system 10. Here, for the sake of convenience, the calculation of the five current commands Iref″″A1 to Iref″″A5 will be described.

$${Iref}^{′′′′} A 1 = KA 1 \cdot CA 1 / ( KA 1 \hat{} 2 \cdot CA 1 + KA 2 \hat{} 2 \cdot CA 2 + KA 3 \hat{} 2 \cdot CA 3 + KA 4 \hat{} 2 \cdot CA 4 + KA 5 \hat{} 2 \cdot CA 5 ) \times τ ref \qquad formula ( 5 )$$

$${Iref}^{′′′′} A 2 = KA 2 \cdot CA 2 / ( KA 1 \hat{} 2 \cdot CA 1 + KA 2 \hat{} 2 \cdot CA 2 + KA 3 \hat{} 2 \cdot CA 3 + KA 4 \hat{} 2 \cdot CA 4 + KA 5 \hat{} 2 \cdot CA 5 ) \times τ ref$$

$${Iref}^{′′′′} A 3 = KA 3 \cdot CA 3 / ( KA 1 \hat{} 2 \cdot CA 1 + KA 2 \hat{} 2 \cdot CA 2 + KA 3 \hat{} 2 \cdot CA 3 + KA 4 \hat{} 2 \cdot CA 4 + KA 5 \hat{} 2 \cdot CA 5 ) \times τ ref$$

$${Iref}^{′′′′} A 4 = KA 4 \cdot CA 4 / ( KA 1 \hat{} 2 \cdot CA 1 + KA 2 \hat{} 2 \cdot CA 2 + KA 3 \hat{} 2 \cdot CA 3 + KA 4 \hat{} 2 \cdot CA 4 + KA 5 \hat{} 2 \cdot CA 5 ) \times τ ref$$

$${Iref}^{′′′′} A 5 = KA 5 \cdot CA 5 / ( KA 1 \hat{} 2 \cdot CA 1 + KA 2 \hat{} 2 \cdot CA 2 + KA 3 \hat{} 2 \cdot CA 3 + KA 4 \hat{} 2 \cdot CA 4 + KA 5 \hat{} 2 \cdot CA 5 ) \times τ ref$$

In formula (5), CA1 to CA5 are virtual conductances, and are coefficients introduced to adjust the values of the current commands Iref″″A calculated by the current command generation unit 13″″. The virtual conductances CA1 to CA5 can be determined from the virtual conductance distribution CA(x).

It is known that the relationship between the currents flowing through the coils 9A1 to 9A5 and the thrust τ produced on the mover 4 is expressed by formula (6) below.

$$τ = KA 1 \cdot IA 1 + KA 2 \cdot IA 2 + KA 3 \cdot IA 3 + KA 4 \cdot IA 4 + KA 5 \cdot IA 5 \qquad formula ( 6 )$$

Although a detailed formula transformation is omitted, when τ in formula (6) is substituted into tref in formula (5), the current commands Iref″″A1 to Iref″″A5 calculated with formula (5) allow the thrust τ produced on the mover 4 to be the thrust command tref, which is the target value of the thrust τ, regardless of the values of the virtual conductances CA1 to CA5. That is, even when the virtual conductances CA1 to CA5 are introduced, the thrust τ produced on the mover 4 does not deviate from the thrust command tref.

According to the equations in formula (5), when the products of the thrust coefficients KA1 to KA5 and the virtual conductances CA1 to CA5 are zero, the current commands Iref″″A of 0 [A] are generated. The current commands Iref″″A of 0 [A] are input to the current control units 22A via the data communication units 14 and 21A. The current control units 22A control the currents flowing through the coils 9A to 0 [A]. Consequently, no drive currents flow through the coils 9A to which the current commands Iref″″A of 0 [A] are provided.

On the other hand, when the products of the thrust coefficients KA1 to KA5 and the virtual conductances CA1 to CA5 are not zero, the current commands Iref″″A that are not 0 [A] are generated. The current commands Iref″″A that are not 0 [A] are input to the current control units 22A via the data communication units 14 and 21A. The current control units 22A control the currents flowing through the coils 9A to values other than 0 [A]. Consequently, drive currents flow through the coils 9A to which the current commands Iref″″A that are not 0 [A] are provided.

As can be understood from the above description, in the case where the equations in formula (5) are used, by adjusting the values of the virtual conductances CA1 to CA5 by which the thrust coefficients KA1 to KA5 are multiplied, the number of the coils through which the drive currents flow can be changed as desired, and the number of the coils through which to pass the drive currents can be reduced without connecting switches to the plurality of coils 9. That is, the generation of the current commands Iref″″A so as to reduce the number of the coils through which the drive currents flow, using the virtual conductances CA1 to CA5 by which the thrust coefficients KA1 to KA5 are multiplied is the generation of the current target values to be provided to the plurality of coils 9, using part of the actual thrust characteristic determined by the characteristics of the plurality of coils 9 and the mover 4.

Further, by using the virtual conductance distribution CA(x) that allows the characteristics of changes in values obtained when the thrust coefficients KA1 to KA5 are multiplied by the virtual conductances CA1 to CA5, respectively, to have values that do not deviate from the values of the actual thrust characteristic determined by the actual thrust coefficient distribution KA(x), the current commands Iref′″ that continuously and smoothly change can be generated.

As described above, in the transfer system and the control device according to the fourth embodiment, the current command generation unit generates the current target values to be provided to the plurality of coils, using the modified thrust characteristic created using the actual thrust characteristic determined by the characteristics of the plurality of coils and the mover, and the correction coefficient that varies according to the position of the mover. That is, in the transfer system and the control device according to the fourth embodiment, the current command generation unit generates the current target values to be provided to the plurality of coils, using part of the actual thrust characteristic determined by the characteristics of the plurality of coils and the mover. Consequently, the errors between the currents flowing through the coils and the current commands can be reduced, and the plurality of movers can be controlled with high accuracy.

The fourth embodiment has described the operation and its effect in the case of using the control device 1 and the drive device 2A illustrated in FIG. 3. However, the operation may be performed using the control device 1′ and the drive device 2A illustrated in FIGS. 5 and 9, or the operation may be performed using the control device 1″ and the drive device 2A illustrated in FIG. 6, or the operation may be performed using the control device 1′″ and the drive device 2A′″ illustrated in FIG. 7. Further, the operation may be performed with the control device 1′ and the drive device 2A illustrated in FIG. 5, using the modified thrust coefficient distribution K′″A(x) described in the third embodiment. This can provide the effects obtained in the first to third embodiments and the effect obtained in the fourth embodiment.

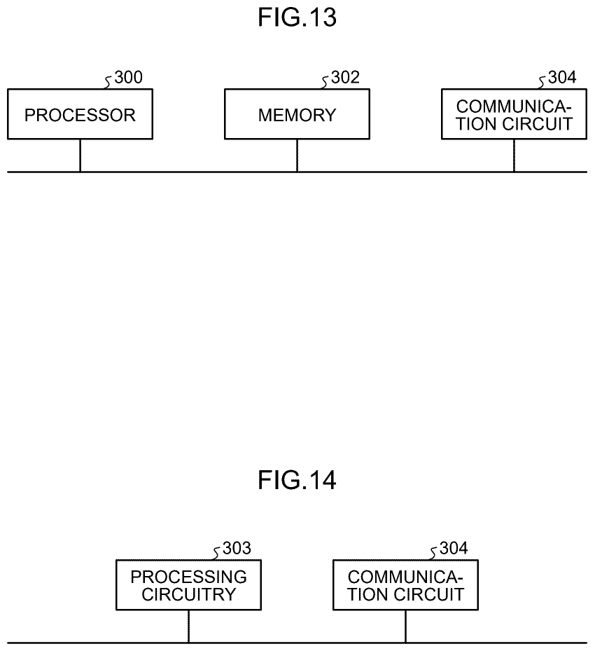

Finally, with reference to FIGS. 13 and 14, a hardware configuration to implement the functions of the control devices 1 to 1″″ and the drive devices 2A to 2H described above will be described. FIG. 13 is a block diagram illustrating an example of a hardware configuration that implements the functions of the control devices 1 to 1″″ and the drive devices 2A to 2H in the first to fourth embodiments. FIG. 14 is a block diagram illustrating another example of a hardware configuration that implements the functions of the control devices 1 to 1″″ and the drive devices 2A to 2H in the first to fourth embodiments.

In the case where part or all of the functions of the control devices 1 to 1″″ and the drive devices 2A to 2H in the first to fourth embodiments are implemented, as illustrated in FIG. 13, a configuration including a processor 300 that performs arithmetic operations, memory 302 that stores a program to be read by the processor 300, and a communication circuit 304 that transmits and receives signals can be used.

The processor 300 is an example of an arithmetic means. The processor 300 may be an arithmetic means called a microprocessor, a microcomputer, a central processing unit (CPU), or a digital signal processor (DSP). The memory 302 can be exemplified by nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disc, a mini disc, or a digital versatile disc (DVD).

The memory 302 stores a program to perform the functions of the control devices 1 to 1″″ and the drive devices 2A to 2H in the first to fourth embodiments. The processor 300 gives and receives necessary information via the communication circuit 304. The processor 300 executes the program stored in the memory 302. The processor 300 refers to a table stored in the memory 302. Consequently, the above-described processing can be performed. The results of arithmetic operations performed by the processor 300 can be stored in the memory 302.

In the case where part of the functions of the control devices 1 to 1″″ and the drive devices 2A to 2H in the first to fourth embodiments are implemented, processing circuitry 303 illustrated in FIG. 14 may be used. The processing circuitry 303 corresponds to a single circuit, a combined circuit, an application specific integrated circuit (ASIC), a field-programmable gate array (FPGA), or a combination thereof. Information to be input to the processing circuitry 303 and information to be output from the processing circuitry 303 can be received or given through the communication circuit 304.

Part of the processing in the control devices 1 to 1″″ and the drive devices 2A to 2H may be performed by the processing circuitry 303, and the processing not performed by the processing circuitry 303 may be performed by the processor 300 and the memory 302.

The configurations described in the above embodiments illustrate an example, and can be combined with another known art. The embodiments can be combined with each other. The configurations can be partly omitted or changed without departing from the gist.

### REFERENCE SIGNS LIST

1, 1′, 1″, 1′″, 1″″ control device; 2, 2A to 2H drive device; 3, 3A to 3H coil unit; 4, 4A to 4C mover; 5, 5A to 5C scale head; 6, 6A, 6B linear scale; 7 data communication line; 7A, 7B communication line; 8 transfer path; 9, 9A1 to 9A5, 9B1, 9B2 coil; 10 transfer system; 11 motion target value generation unit; 12, 25A′″ position and speed control unit; 13, 13′, 13″, 13″″, 26A′″ current command generation unit; 14, 21A, 21B data communication unit; 15, 15″, 15′″ thrust command generation unit; 17A, 17B arrow; 20A, 20B drive unit; 22A, 22A1 to 22A5 current control unit; 23A, 23A1 to 23A5 current detector; 24A, 24B detector communication unit; 40 permanent magnet; 300 processor; 302 memory; 303 processing circuitry; 304 communication circuit.

1. A transfer system comprising a mover and a transfer path along which the mover moves, the transfer system comprising:
drive circuitry to supply drive currents to a plurality of coils disposed along the transfer path;
thrust command generation to generate a thrust command that is a command value of a thrust to be produced by the mover, based on a motion target value that is a time-series motion target value input from outside or internally generated; and
current command generation circuitry to generate, as current commands, current target values that are target values of the drive currents to be provided to the plurality of coils so that the thrust produced by the mover follows the thrust command, wherein
the current command generation circuitry generates the current target values to be provided to the plurality of coils, using part of an actual thrust characteristic determined by characteristics of the plurality of coils and the mover, so as to make the number of the coils through which the drive currents flow smaller than the number of the coils through which the drive currents flow when based on the actual thrust characteristic.

2. The transfer system according to claim 1, wherein
the thrust command generation circuitry generates the thrust command so that a motion detection value representing a moving position or a moving speed of the mover follows the motion target value.

3. The transfer system according to claim 2, wherein
the transfer system comprises a drive device and a control device,
the drive device includes the drive circuitry,
the control device includes the current command generation circuitry and the thrust command generation circuitry, and
the thrust command generation circuitry includes
motion target value generation circuitry to generate the motion target value, and
position and speed control circuitry to generate the thrust command so that the motion detection value follows the motion target value.

4. The transfer system according to claim 2, wherein
the transfer system comprises a drive device and a control device,
the thrust command generation circuitry includes
motion target value generation circuitry to generate the motion target value, and
position and speed control circuitry to generate the thrust command so that the motion detection value follows the motion target value,
the drive device includes the drive circuitry, the position and speed control circuitry, and the current command generation circuitry, and
the control device includes the motion target value generation circuitry.

5. The transfer system according to claim 1, wherein
the transfer system comprises a plurality of the movers, and
when a plurality of coils to drive a first mover that is any one of the plurality of movers are referred to as a first coil group, and a plurality of coils to drive a second mover adjacent to the first mover are referred to as a second coil group,
the current command generation circuitry generates current target values to be provided to the coils of the first coil group, using part of an actual thrust characteristic determined by characteristics of the coils of the first coil group and the first mover, and
the current command generation circuitry generates current target values to be provided to the coils of the second coil group, using part of an actual thrust characteristic determined by characteristics of the coils of the second coil group and the second mover.

6. (canceled)

7. The transfer system according to claim 1, wherein
the current command generation circuitry generates the current target values to be provided to the plurality of coils, using a modified thrust characteristic created by using the actual thrust characteristic determined by the characteristics of the plurality of coils and the mover and a correction coefficient that varies according to a position of the mover.

8. A control device configured to be applicable to a transfer system comprising a mover, a transfer path along which the mover moves, and a drive device to supply drive currents to a plurality of coils disposed along the transfer path, the control device comprising:
thrust command generation circuitry to generate a thrust command that is a command value of a thrust to be produced by the mover, based on a motion target value that is a time-series motion target value input from outside or internally generated; and
current command generation circuitry to generate, as current commands, current target values that are target values of the drive currents to be provided to the plurality of coils so that the thrust produced by the mover follows the thrust command, wherein
the current command generation circuitry generates the current target values to be provided to the plurality of coils, using part of an actual thrust characteristic determined by characteristics of the plurality of coils and the mover, so as to make the number of the coils through which the drive currents flow smaller than the number of the coils through which the drive currents flow when based on the actual thrust characteristic.

9. The control device according to claim 8, wherein
in a case where the transfer system comprises a plurality of the movers, when a plurality of coils to drive a first mover that is any one of the plurality of movers are referred to as a first coil group, and a plurality of coils to drive a second mover adjacent to the first mover are referred to as a second coil group,
the current command generation circuitry generates current target values to be provided to the coils of the first coil group, using part of an actual thrust characteristic determined by characteristics of the coils of the first coil group and the first mover, and
the current command generation circuitry generates current target values to be provided to the coils of the second coil group, using part of an actual thrust characteristic determined by characteristics of the coils of the second coil group and the second mover.

10. (canceled)

11. The control device according to claim 8, wherein
the current command generation circuitry generates the current target values to be provided to the plurality of coils, using a modified thrust characteristic created by using the actual thrust characteristic determined by the characteristics of the plurality of coils and the mover and a correction coefficient that varies according to a position of the mover.
